(19) United States
(12) Patent Application Publication
(10) Pub. No.: US 2005/0132025 A1
(43) Pub. Date: Jun. 16, 2005

(54) Method and system for processing multimedia data

(76) Inventors: Yu-Chen Tsai, Taipei City (TW); Chih-Chun Lai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/808,822

(22) Filed: Mar. 25, 2004

(30) Foreign Application Priority Data
Dec. 15, 2003 (TW) 92135352

(51) Int. Cl. G06F 15/16

(52) U.S. Cl. 709/219

(57) ABSTRACT

A method and system for processing multimedia data. A digital content player is first connected to a digital content server via RTSP in accordance with URL information embedded by prototype definition. Next, multimedia data is accessed and processed from the digital content server via RTSP. Finally, remote text data is retrieved via SOAP in accordance with the URL information when text data is processed.

### BACKGROUND OF THE INVENTION

1. Field of the Invention

The present invention relates to a method and system for data processing, and in particular to a method and system for processing multimedia data.

2. Description of the Related Art

Multimedia data is often processed in Internet applications be embedded video and audio streams in web pages, with text or images as needed, for transmission. Interactive multimedia applications may also be used. Conventional methods are often limited by poor synchronization and integration between multimedia streaming objects and web elements, in which the multimedia streaming objects only can be created by web programs and executed in designated players.

Conventional technology is thus unable to provide real-time interaction with users.

### SUMMARY OF THE INVENTION

Accordingly, an object of the present invention is to provide a system for processing multimedia data, integrating MPEG-4 standard players and enabling better synchronization and integration of multimedia video stream, text, and images.

Another object of the invention is to provide a method for processing multimedia data, providing access of streaming data of all types through a web service.

According to the object described, the present invention provides a system for processing multimedia data, comprising a digital content player, including an MPEG-4 system player and a data processing module, and a digital content server, including an access interface module, a video streaming encoder, and an MPEG-4 streaming server.

The digital content player streams multimedia data and displays images and text. The MPEG-4 system player receives and plays multimedia data in MPEG-4 format and executes user operations. The data processing module accesses remote real text data, in which Uniform Resource Locator (URL) information is embedded by prototype definition, through Simple Object Access Protocol (SOAP) and converts the data to images and text for display by the digital content player.

The digital content server delivers multimedia data to a remote program, comprising an access interface module acting as an interface for real text data, video streaming encoder, merging and encoding text and multimedia data, and an MPEG-4 streaming server. In addition, the remote program, such as a data processing module, accesses multimedia data stored in a text database using the access interface module from the Internet via SOAP, in which the text database comprises text data.

The video streaming encoder merges text data stored in the text database and multimedia data stored in the multimedia database according to content templates stored in a content template database, such as MPEG-4 streaming data, transferring the data to the MPEG-4 streaming server. The multimedia database comprises raw video, image, and audio data. The content template database stores content templates referenced for merging multimedia and text data. The MPEG-4 streaming server transfers the MPEG-4 streaming data to the digital content player through Real-Time Streaming Protocol (RTSP) or Real-Time Transport Protocol (RTP).

The present invention further provides a method for processing interactive multimedia data. A digital content player connects to a digital content server through RTSP in accordance with URL information, embedded in text data by prototype definition. Next, the digital content player accesses and plays multimedia data from the digital content server using RTSP. Finally, remote text data is accessed using SOAP in accordance with the URL information when the digital content player acceses the text data.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the architecture of the system for processing multimedia data according to the present invention;

FIG. 2 is a schematic diagram showing URL information embedded in text data according to the present invention;

FIG. 3 is a schematic diagram showing real text data defined by prototype definition of the present invention;

FIG. 4 is a flowchart of the method for processing multimedia streaming data using the digital content player of the present invention;

FIG. 5 is a flowchart of the method for accessing remote text data using the access interface module of the present invention;

FIG. 6 is a flowchart of the method for generating a multimedia file using the Video streaming encoder of present invention;

FIG. 7 is a flowchart of the method for processing multimedia streaming data using the MPEG-4 system player of the present invention.

### DETAILED DESCRIPTION OF THE INVENTION

The present invention discloses a method and system for processing multimedia data. The method integrates MPEG-4 streaming data and web elements, in which MPEG-4 streaming data is represented by Binary Format for Scene (BIFS).

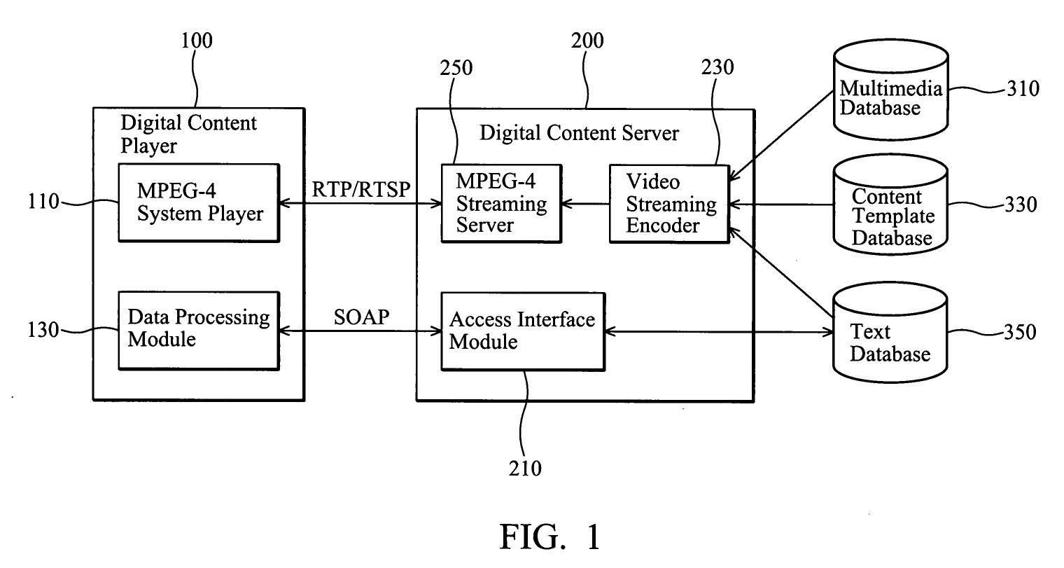

FIG. 1 is a schematic diagram showing the architecture of the system for processing multimedia data according to the present invention.

The architecture comprises a digital content player 100, including an MPEG-4 system player 110 and a data processing module 130, and a digital content server 200, including an access interface module 210, a video streaming encoder 230, and an MPEG-4 streaming server 250.

Digital content player 100 plays multimedia streaming data and interacts with images and text.

MPEG-4 system player 110 receives and executes multimedia data with MPEG-4 format and user operations.

Data processing module 130 accesses remote text data, in which Uniform Resource Locator (URL) information is embedded by prototype definition, through SOAP and converts the data to images and text to be displayed by the digital content player 100.

The digital content server 200 delivers the multimedia data to a remote program, comprising an access interface module 210 accessing the multimedia data, a video streaming encoder 230, merging and encoding text and multimedia data, and an MPEG-4 streaming server 250.

The remote program, such as data processing module 130, accesses multimedia data stored in a text database using access interface module 210 from the Internet via SOAP, in which the text database comprises text data

Video streaming encoder 230 merges text data, stored in text database 350 and multimedia data stored in multimedia database 310 according to content templates, stored in a content template database 330, as MPEG-4 streaming data, for transfer to MPEG-4 streaming server 250. Multimedia database 310 comprises raw video, image, and audio data. Content template database 330 stores content templates referenced for merging multimedia and text data.

MPEG-4 streaming server 250 transfers the MPEG-4 streaming data to digital content player 100 through Real-Time Streaming Protocol (RTSP) or Real-Time Transport Protocol (RTP).

The method of the invention enables MPEG-4 streaming data to be displayed with text data using standard MPEG-4 system players through data packaging, by prototype definition with BIFS. The digital content server of the invention processes text data defined by recognizing prototype specific embedded in the text data.

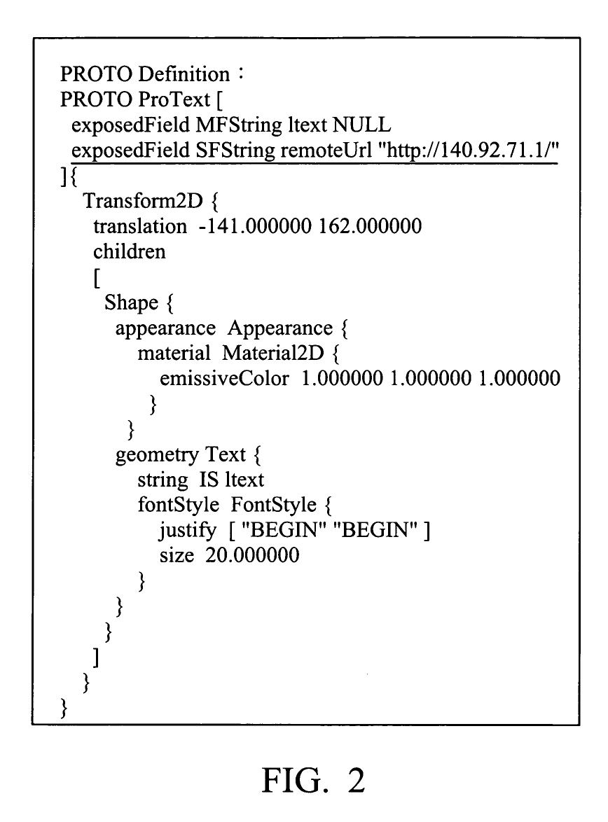

FIG. 2 is a schematic diagram showing URL information embedded in text data according to the present invention. As shown in FIG. 2, the underlined description ┌ exposedField SFString remoteUrl “http://140.92.71.1/” ┘ is the specific information embedded in text data, defined by prototype definition.

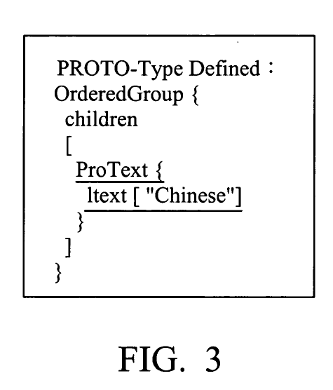

FIG. 3 is a schematic diagram showing real text data defined by prototype definition according to the present invention. As shown in FIG. 3, the underlined program codes enable “Chinese” to be displayed with multimedia data in a browser complying with MPEG-4 standards. In addition, digital content player 100 is associated with a remote website in accordance with URL ┌http://140.92.71.1/┘ relating to the term “Chinese”.

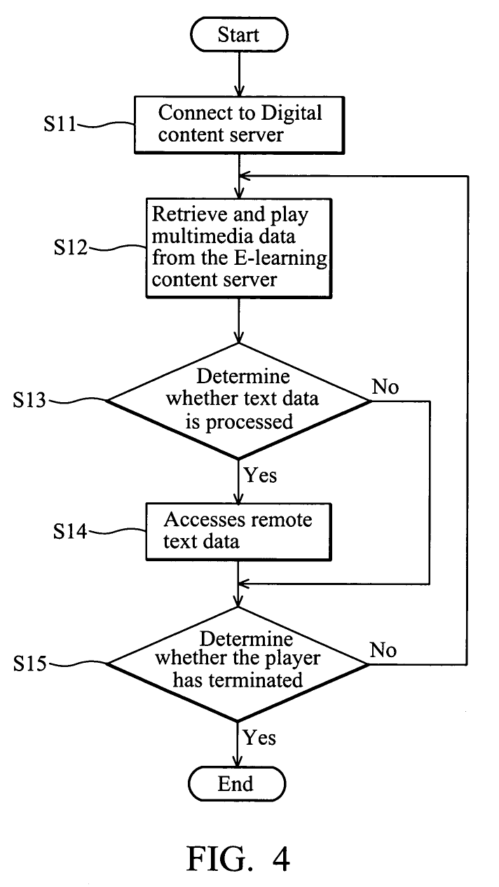

FIG. 4 is a flowchart of the method for processing multimedia streaming data using the digital content player of the present invention.

In step S11, the digital content player connects to the digital content server using RTSP in accordance with given or specified URL information.

In step S12, the digital content player retrieves and plays multimedia data using the video streaming encoder of the digital content server through RTSP.

In step S13, it is determined whether text data is processed, and, if so, the process goes to step S14, and, if not, to step S15.

In step S14, the data processing module of the digital content player accesses remote text data via SOAP according to the URL information embedded in the multimedia data.

In step S15, it is determined whether the process has terminated, and, if so, the digital content player closes, and, if not, the process goes to step S12 to continue the process.

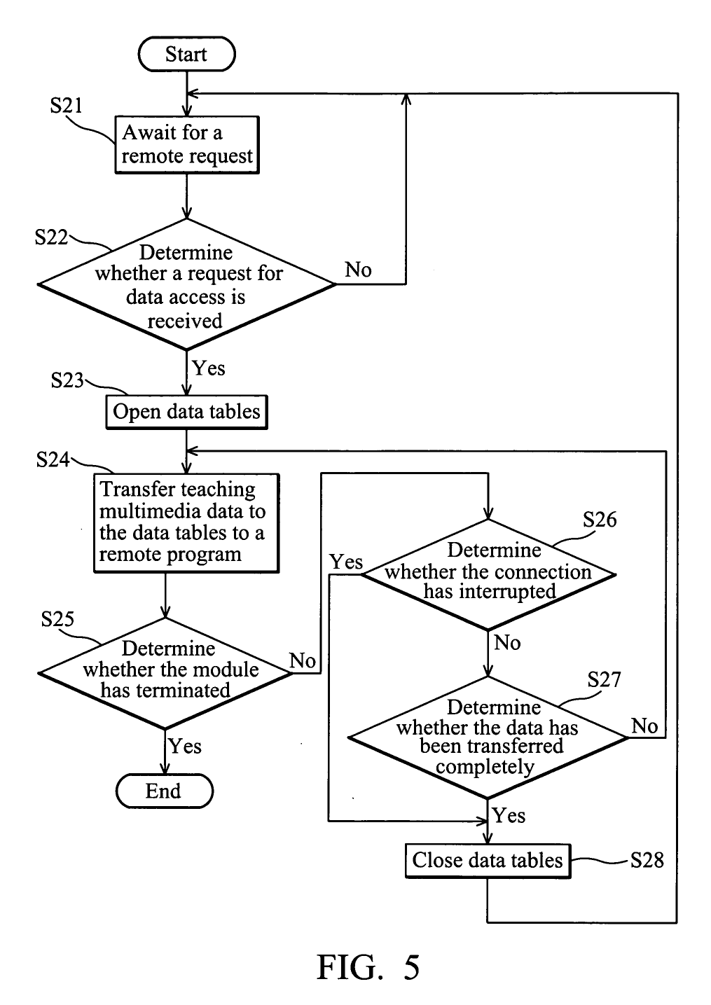

FIG. 5 is a flowchart of the method for accessing remote text data using the access interface module of the present invention.

In step S21, the access interface module awaits remote request from a remote program, such as the data processing module.

In step S22, it is determined whether the request call for data access has been received, and, if so, the process goes to step S23, and, if not, to step S21.

In step S23, the access interface module receives data tables relating to the multimedia data, such as images and text data, from the text database.

In step S24, the multimedia data relating to the data tables is transferred to a remote program via SOAP.

In step S25, it is determined whether the process has terminated, and, if so, the access interface module closes, and, if not, the process goes to step S26.

In step S26, it is determined whether the connection has interrupted, and, if so, the process goes to step S28, and, if not, to step S27.

In step S27, it is determined whether the data has been transferred completely, and, if so, the process goes to step S28, and, if not, to step S24

In step S28, data table access is terminated and the process goes to step S21 to continue the process.

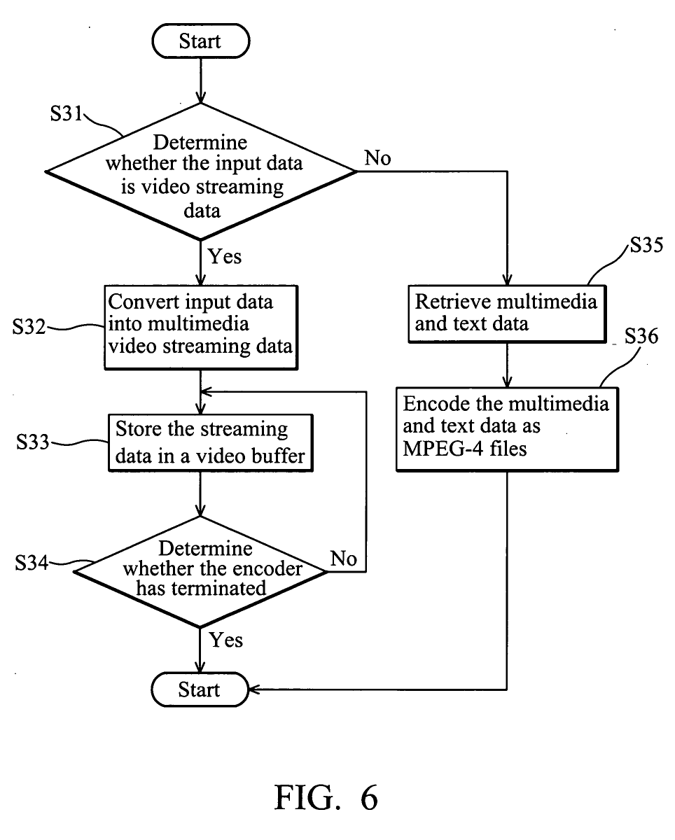

FIG. 6 is a flowchart of the method for generating a multimedia file using the Video streaming encoder of present invention.

In step S31, it is determined whether the input data, given by users or specified by other programs, is video streaming data. If so, the process goes to step S35, and, if not, the process goes to step S32, in which the input data is converted to multimedia video streaming data with MPEG-4 format.

In step S33, the multimedia video streaming data is stored in a video buffer.

In step S34, it is determined whether the encoder has terminated, and, if so, the video streaming encoder closes, and, if not, the process goes to step S32.

In step S35, multimedia and text data stored in the text database are retrieved from the multimedia and text databases if the input data is not video streaming data.

In step S36, the multimedia and text data are encoded as MPEG-4 files in accordance with multimedia and text content templates stored in the content template database. The process is thus terminated.

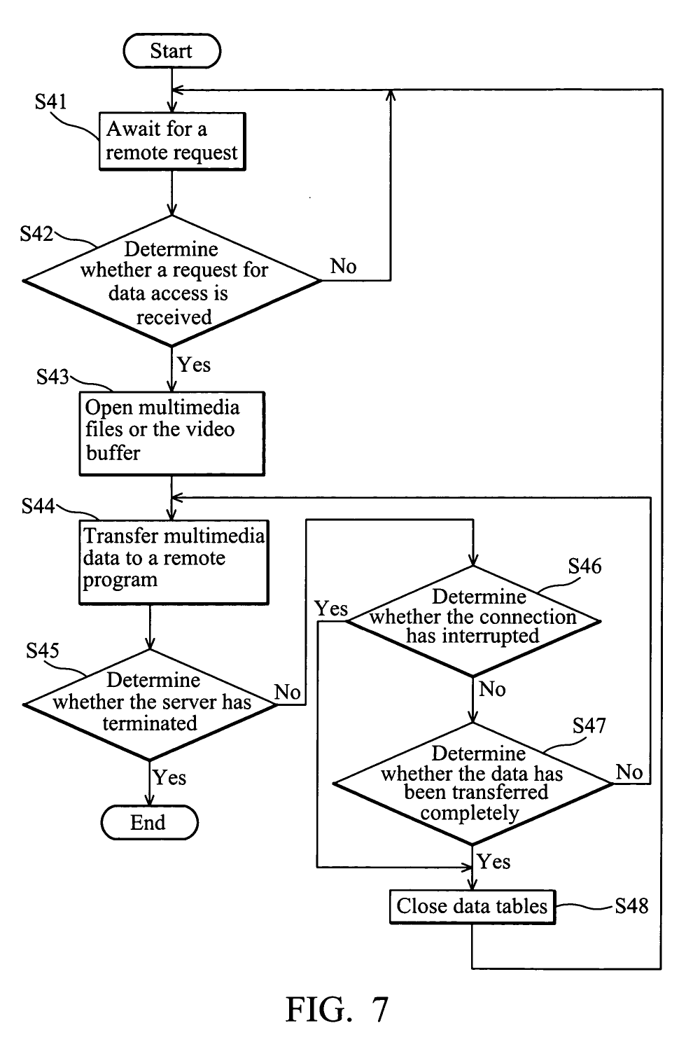

FIG. 7 is a flowchart of the method for processing multimedia streaming data using the MPEG-4 system player of the present invention.

In step S41, the MPEG-4 system player awaits remote request from a remote program, such as the data processing module.

In step S42, it is determined whether the request call for data access has been received, and, if so, the process goes to step S43, and, if not, to step S41.

In step S43, the MPEG-4 system player opens multimedia files generated by the video streaming encoder or the video buffer.

In step S44, the multimedia data is transferred to a remote program via SOAP.

In step S45, it is determined whether the process has terminated, and, if so, the access interface module closes, and, if not, the process goes to step S46.

In step S26, it is determined whether the connection has interrupted, and, if so, the process goes to step S48, and, if not, to step S47.

In step S47, it is determined whether the data has been transferred completely, and, if so, the process goes to step S48, and, if not, to step S44.

In step S48, data table access is terminated and the process goes to step S41 to continue the process.

The method of the invention integrates MPEG-4 standard players and enables improved synchronization and integration with multimedia streaming, text, and images.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A system for processing multimedia data, comprising:
a digital content server, merging text and multimedia data into a multimedia file according to content templates, and retrieving text data, in which URL information is embedded by prototype definition, from the Internet; and
a digital content player, coupled to the digital content server, obtaining and playing the multimedia file using RTSP, and retrieving the text data from the digital content server using SOAP according to the URL information.

2. The system as claimed in claim 1, wherein the digital content server further comprises a video streaming encoder, merging the text and multimedia data into the multimedia file.

3. The system as claimed in claim 1, wherein the digital content server further comprises an access interface module, retrieving the text data from the Internet, accessed by the digital content player via SOAP.

4. The system as claimed in claim 1, wherein the digital content player further comprises a data processing module, accessing the text data according to the URL information.

5. The system as claimed in claim 1, wherein the multimedia file is an MPEG-4 format file or a multimedia video stream.

6. The system as claimed in claim 1, wherein the content templates include multimedia and text templates.

7. A system for processing interactive multimedia data, comprising:
an access interface module, retrieving real text data from a text database;
a video streaming encoder, merging text data, stored in the text database, and multimedia data into a multimedia file according to content templates; and
an MPEG-4 stream server, coupled to the video streaming encoder, retrieving the multimedia file from the video streaming encoder, for delivery to an MPEG-4 system player.

8. The system as claimed in claim 7 further comprising a data processing module, retrieving text data in which URL information is embedded by prototype definition, from the access interface module via SOAP.

9. The system as claimed in claim 8, wherein the MPEG-4 system player retrieves and plays the multimedia file from the MPEG-4 stream server, and retrieves the real text data from the access interface module via SOAP according to the URL information.

10. The system as claimed in claim 8, wherein the data processing module converts the text data to images and text.

11. The system as claimed in claim 7 further comprising a content template database, storing the content templates.

12. The system as claimed in claim 7, wherein the multimedia file is an MPEG-4 format file or a multimedia video stream.

13. The system as claimed in claim 7, wherein the MPEG-4 system player obtains the multimedia file via RTSP.

14. The system as claimed in claim 7, wherein the content templates include multimedia and text templates.

15. A method for processing interactive multimedia data, comprising the steps of:
connecting to a digital content server in accordance with URL information, embedded in real text data by proto-type definition;
merging multimedia and text data, retrieved from the Internet, as a multimedia file;
accessing and playing the multimedia file retrieved from the digital content server;
determining whether the text data is processed;
retrieving the text data according to the URL information through a web accessing interface if the text data is processed.

16. The method as claimed in claim 15, wherein merging step further comprises:
determining whether the retrieved data is video data;
converting the retrieved data to a multimedia video stream if the retrieved data is the video data;
storing the multimedia video stream in a video buffer;
retrieving the multimedia and text data from the Internet if the retrieved data is not the video data; and
merging the multimedia and text data into the multimedia file.

17. The method as claimed in claim 15, wherein determination step further comprises:
determining whether an access request is retrieved; and
retrieving the text data from a text database if the access request is retrieved.

18. The method as claimed in claim 15, wherein the digital content server is connected via RTSP.

19. The method as claimed in claim 15, wherein the real text data is retrieved via SOAP.

20. The method as claimed in claim 15, wherein the multimedia file is an MPEG-4 format file or a multimedia video stream.
